(19) United States
(12) Patent Application Publication
(10) Pub. No.: US 2013/0180675 A1
(43) Pub. Date: Jul. 18, 2013

(54) HEAVY DUTY HIGH PERFORMANCE SLIDING SCREEN FOR SLIDING GLASS, FRENCH AND GARAGE DOORS

(71) Applicants: Paul R. Bates, Fort Pierce, FL (US); Ashley Lauren Bates, Poland, OH (US)

(72) Inventors: Paul R. Bates, Fort Pierce, FL (US); Ashley Lauren Bates, Poland, OH (US)

(21) Appl. No.: 13/736,922

(22) Filed: Jan. 8, 2013

Related U.S. Application Data
(60) Provisional application No. 61/586,542, filed on Jan. 13, 2012.

(51) Int. Cl. E06B 9/24

(52) U.S. Cl. CPC E06B 9/24
USPC 160/381

(57) ABSTRACT

A sliding screen frame is designed with sufficient strength to not bind, bend or sag, allowing the sliding screen frame to open and close easily every time. Stainless steel wire screening can protect against vandalism, weather conditions, pets, children and everyday use, while being impact resistant, increasing security, and protection against theft. Rollers on the top and bottom of the sliding screen frame can adjust and lock into place so that the screen insert frame cannot be easily removed by intruders. The rollers also allow the sliding screen frame to roll easily along the sill tracks.

### CROSS-REFERENCE TO RELATED APPLICATION

This application claims the benefit of priority of U.S. provisional application No. 61/586,542, filed Jan. 13, 2012, the contents of which are herein incorporated by reference.

### BACKGROUND OF THE INVENTION

The present invention relates to sliding screens and, more particularly, to a heavy duty, high performance sliding screen that can be used in, for example, sliding glass doors, French doors, and garage doors.

Conventional sliding screen insert frames easily come apart. Because they are often made of light or low gauge materials and their corner construction is usually quite weak, they easily bind, bend or sag, causing their opening and closing difficulty.

The screening material is often made of fiberglass, nylon or very light wire mesh that tears and rips easily. The screening material is usually held in place with a vinyl spline that allows the screening to be pushed out of the framing with very little effort. The screening material itself has limited performance and can tear and require repairs or total replacement when damaged by weather conditions, pets, children, everyday use and vandalism. The conventional screening material further does not provide any security or protection against theft.

Because of these limitations with conventional sliding screens, manufacturers often only offer very limited warranties on their screen frames, typically a year or less, and usually offer no warranty on the screening material itself.

As can be seen, there is a need for an improved sliding screen frame and screening that can overcome the above described issues with conventional sliding screens.

### SUMMARY OF THE INVENTION

In one aspect of the present invention, a screen frame comprises a frame; a screen disposed inside the frame and attached to the frame; a corner gusset disposed within the frame at each corner thereof, the corner gusset being a rigid member extending in each direction at each corner of the frame; and a wire retainer lock strip disposed in a pocket formed along an inner periphery of the frame, the wire retainer lock strip being disposed over ends of the screen, wherein the screen is formed from a wire mesh made of stainless steel wires having a diameter from about 0.016 inch to about 0.032 inch.

In another aspect of the present invention, a screen frame comprises a frame; a screen disposed inside the frame and attached to the frame; a corner gusset disposed within the frame at each corner thereof, the corner gusset being a rigid member extending in each direction at each corner of the frame; a wire retainer lock strip disposed in a pocket formed along an inner periphery of the frame, the wire retainer lock strip being disposed over ends of the screen; a cover disposed over the wire retainer lock strip; a plurality of adjustable rollers disposed on a top side and a bottom side of the frame; and an adjustment screw on each of the plurality of adjustable rollers, the adjustment screws operable to adjust the position of the adjustable rollers, wherein the screen is formed from a wire mesh made of stainless steel wires having a diameter from about 0.016 inch to about 0.032 inch.

These and other features, aspects and advantages of the present invention will become better understood with reference to the following drawings, description and claims.

### BRIEF DESCRIPTION OF THE DRAWINGS

FIG. 1 is a perspective view of a sliding screen, installed, according to an exemplary embodiment of the present invention;

FIG. 2 is a detailed front view of an adjustable roller of the sliding screen of FIG. 1, in a lowered configuration;

FIG. 3 is a detailed front view of the adjustable roller of FIG. 2, illustrating turning of an adjustment mechanism for adjusting the height thereof;

FIG. 4 is a detailed, cut-away perspective view of an outside handle portion of the sliding screen of FIG. 1;

FIG. 5 is a detailed, cut-away perspective view of an inside handle portion of the sliding screen of FIG. 1, further illustrating one adjustable roller and a corner gusset;

FIG. 6 is a perspective view of a corner gusset used in the sliding screen of FIG. 1;

FIG. 7 is a partially cut-away interior view of the sliding screen of FIG. 1; and

FIG. 8 is a cross-sectional view taken along line 8-8 of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a sliding screen frame that is designed with sufficient strength to not bind, bend or sag, allowing the sliding screen frame to open and close easily every time. Stainless steel wire screening can protect against vandalism, weather conditions, pets, children and everyday use, while being impact resistant, increasing security, and protection against theft. Rollers on the top and bottom of the sliding screen frame can adjust and lock into place so that the screen insert frame cannot be easily removed by intruders. The rollers also allow the sliding screen frame to roll easily along the sill tracks.

Referring to FIG. 1, a frame 10 can be made from aluminum, such as 6063-TS or T6 high tensile (22,000 psi) aluminum extrusions. The extrusions can have a wall thickness from about 0.062 inch to about 0.125 inch. The frame 10 can form a stable border for a screen 12 that will not bend, sag or bind. The screen 12 can be a stainless steel screen having a wire diameter from about 0.016 inch to about 0.032 inch. The screen 12 can be permanently inserted into the aluminum frame 10.

The frame 10 can include a plurality of adjustable rollers 34 on along a head 42 and a sill 40 side of the frame 10. Typically, at least two adjustable rollers 34 can be disposed on opposite sides of the frame 10.

The frame 10 can include a sliding door jam 38 fitting into a frame jam 36. A inside lock 24 can be seen on an interior facing surface 44 of the frame 10.

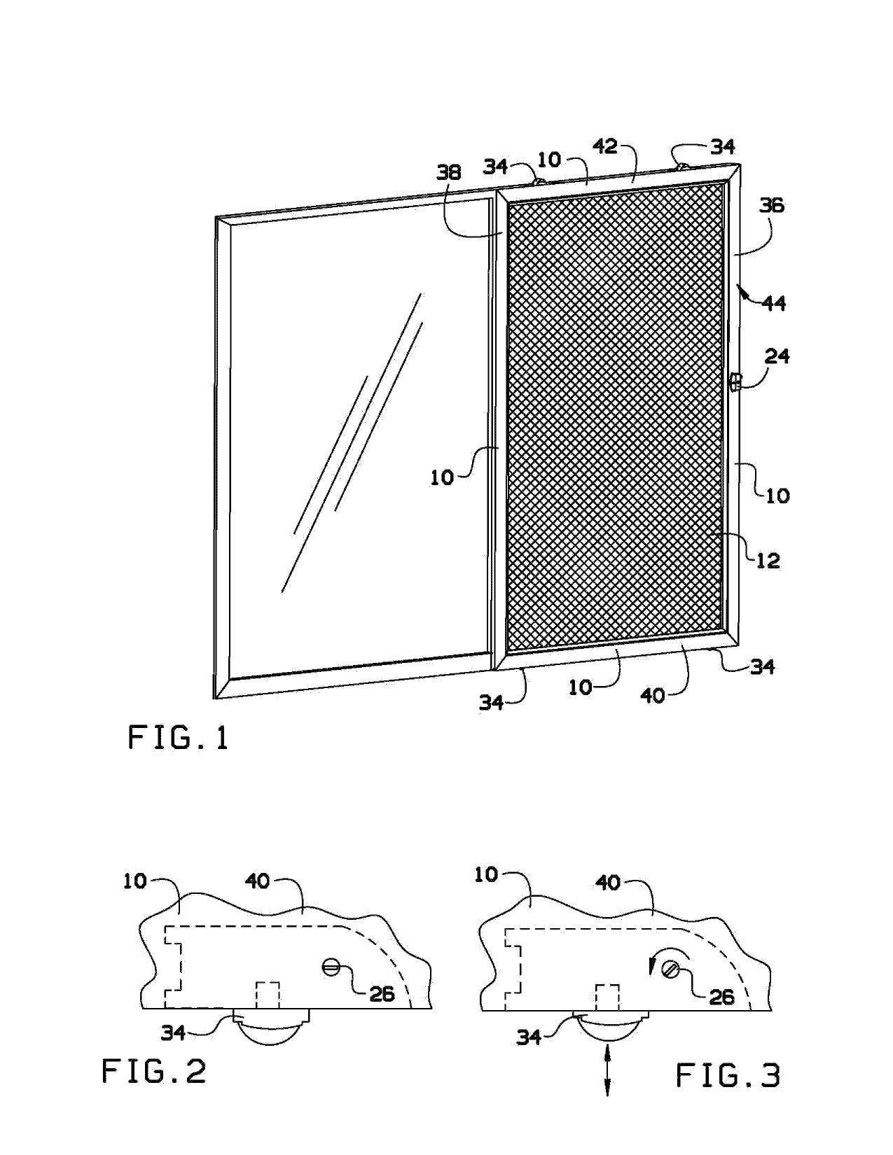

Referring now to FIGS. 2 and 3, detailed views of the adjustable rollers 34 are shown. A screw adjustment 26 can be provided to extend and retract the adjustable rollers 34 from the frame 10. The screw adjustment 26 can be disposed on an interior facing surface 44 so that, once adjusted, they cannot be lowered to allow removal of the frame 10 from the outside.

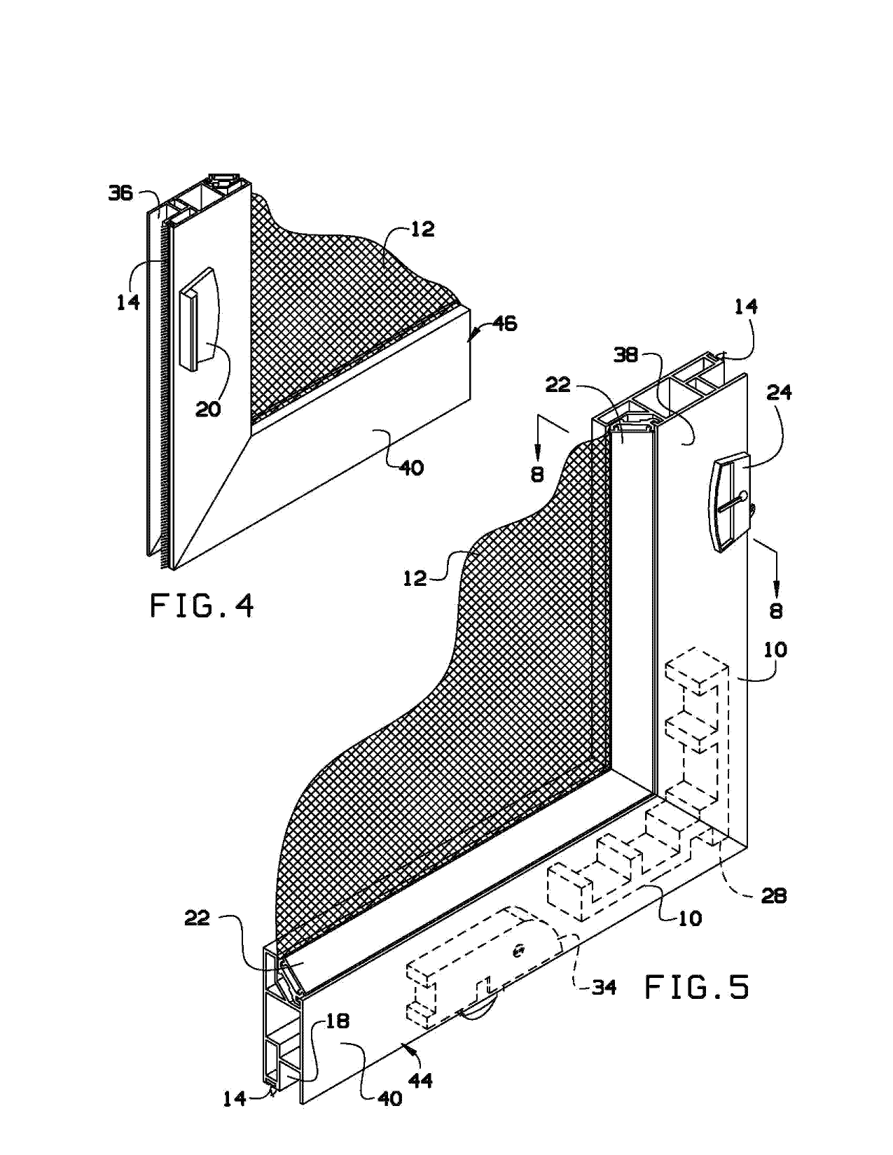

Referring to FIG. 4, an outside handle 20 is shown on an exterior facing surface 46 of the frame 10. A side weather strip 14 can be disposed along the frame jam 36 to provide a seal for the frame 10 when closed.

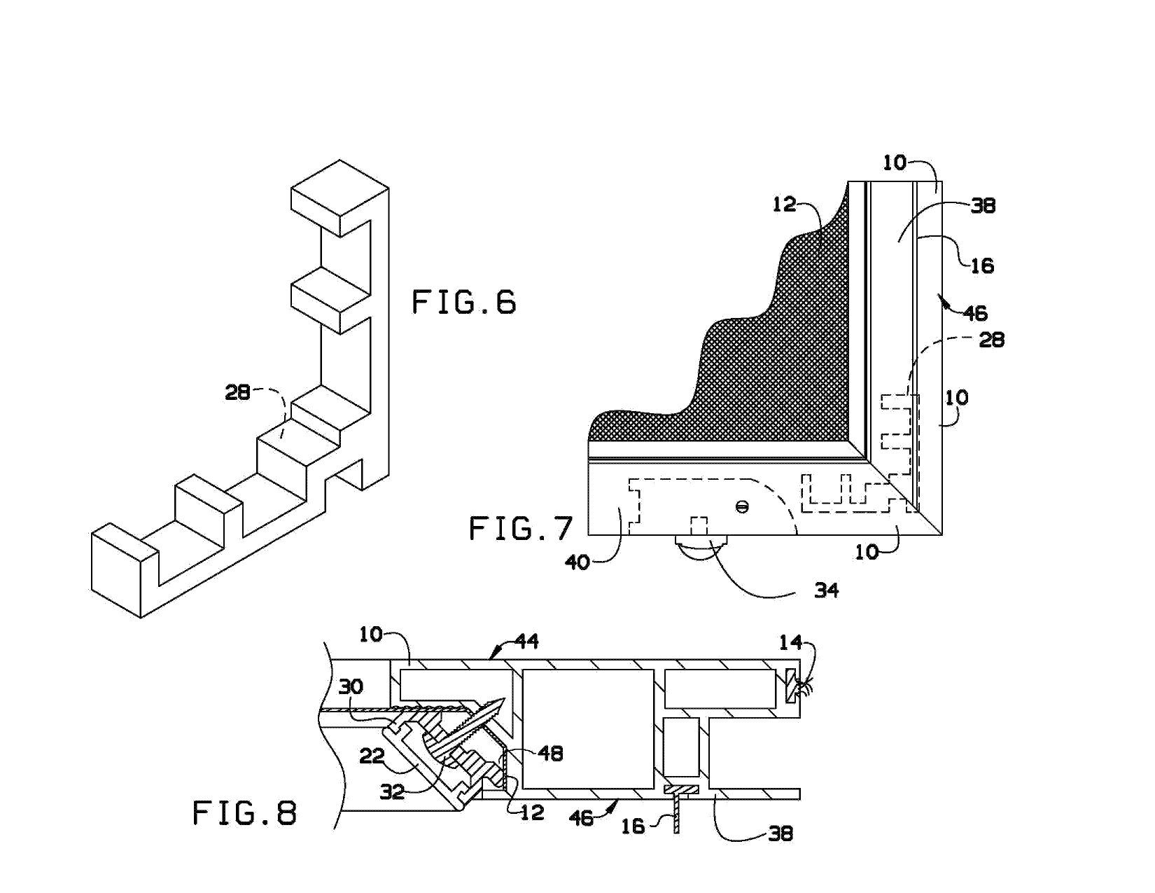

Referring now to FIGS. 5 through 7, corner gussets 28 may be disposed in each corner of the frame 10. The corner gussets 28 can be made from a rigid material, such as aluminum, and may be designed to span each corner of the frame. The corner gussets 28 can include a plurality of stiffening teeth to provide structural rigidity.

An inside lock 24 can be disposed on an interior facing surface 44 of the frame 10. The inside lock 24 can be made from, for example, a strong metal to help prevent unauthorized entry through the sliding screen frame when the frame is closed and locked.

Referring to FIG. 8, the screen 12 can be secured to the frame 10 with a wire retainer lock strip 30. Typically, an inside corner (pocket) can be formed along an inner periphery on the inner facing surface 44 of the frame 10. The screen 12 can span between the pocket formed about the frame and the screen wire retainer lock strip 30 can be secured over the edges of the screen 12 and into the frame 10 with a plurality of fasteners 32, typically spaced about 4 inches apart. In some embodiments, a bonding adhesive 48 can be disposed between the wire retainer lock strip 30 and the frame 10 to permanently bond the screen 12 to the frame 10. A cover 22 can be placed over the retainer lock strip 30 to provide a finished look. In some embodiments, the cover 22 can be a vinyl cover having angled protrusions that fit into angled slots of the wire retainer lock strip 30. Other mechanisms, however, may be used to place the cover 22 over the wire retainer lock strip 30 about the inner periphery of the frame 10. The screen 12, secured to the frame 10, can resist high impact blows, child, pet and lawn care damage. The screen 12 also provides vandal resistance and safety protection.

Weather stripping 16 can be provided on the inside of the frame 10 to help keep insects out at the sliding glass door, French door or garage door sliding screens sash meeting rails and frame.

The design of the present invention can not only be used for sliding screen doors, sliding garage screens and French doors, but may also be used for other screen enclosures.

It should be understood, of course, that the foregoing relates to exemplary embodiments of the invention and that modifications may be made without departing from the spirit and scope of the invention as set forth in the following claims.

What is claimed is:

1. A screen frame comprising:
a frame;
a screen disposed inside the frame and attached to the frame;
a corner gusset disposed within the frame at each corner thereof, the corner gusset being a rigid member extending in each direction at each corner of the frame; and
a wire retainer lock strip disposed in a pocket formed in an inside periphery of the frame, the wire retainer lock strip being disposed over ends of the screen, wherein
the screen is formed from a wire mesh made of stainless steel wires having a diameter from about 0.016 inch to about 0.032 inch.

2. The screen frame of claim 1, wherein the frame is an aluminum frame having a thickness from about 0.062 inch to about 0.125 inch.

3. The screen frame of claim 1, further comprising a cover disposed over the wire retainer lock strip.

4. The screen frame of claim 1, further comprising an adhesive disposed between the wire retainer lock strip and the screen and the frame.

5. The screen frame of claim 1, further comprising an inner weather strip disposed on an interior facing surface of the frame.

6. The screen frame of claim 1, further comprising a side weather strip disposed along a sliding door jam side of the frame.

7. The screen frame of claim 1, further comprising a plurality of adjustable rollers disposed on a top side and a bottom side of the frame.

8. The screen frame of claim 7, further comprising an adjustment screw on each of the plurality of adjustable rollers, the adjustment screws operable to adjust the position of the adjustable rollers.

9. A screen frame comprising:
a frame;
a screen disposed inside the frame and attached to the frame;
a corner gusset disposed within the frame at each corner thereof, the corner gusset being a rigid member extending in each direction at each corner of the frame;
a wire retainer lock strip disposed in a pocket formed in an inside periphery of the frame, the wire retainer lock strip being disposed over ends of the screen;
a cover disposed over the wire retainer lock strip;
a plurality of adjustable rollers disposed on a top side and a bottom side of the frame; and
an adjustment screw on each of the plurality of adjustable rollers, the adjustment screws operable to adjust the position of the adjustable rollers, wherein
the screen is formed from a wire mesh made of stainless steel wires having a diameter from about 0.016 inch to about 0.032 inch.

10. The screen frame of claim 9, wherein the frame is an aluminum frame having a thickness from about 0.062 inch to about 0.125 inch.

11. The screen frame of claim 9, further comprising an adhesive disposed between the wire retainer lock strip and the screen and the frame.

12. The screen frame of claim 1, further comprising:
an inner weather strip disposed on an interior facing surface of the frame; and
a side weather strip disposed along a sliding door jam side of the frame.
